(19) United States
(12) Patent Application Publication
(10) Pub. No.: US 2005/0096775 A1
(43) Pub. Date: May 5, 2005

(54) Method and system of automatic carrier transfer

(76) Inventors: Yu-Chih Wang, Kaohsiung (TW); Chung-Sheng Wu, Hsinchu (TW); Hsiang-Jui Cheng, Hsinchu (TW); Dan Ho, Hsinchu (TW); Yin-Hung Chen, Hsinchu (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/698,161

(22) Filed: Oct. 31, 2003

(51) Int. Cl. G06F 19/00

(52) U.S. Cl. 700/112; 700/228

(57) ABSTRACT

A method of automatic carrier transfer. First, a data verification procedure is executed after a first process operation according to a MES database, and a verification result is obtained thereafter. Next, a carrier transfer sub-route is produced and executed according to the verification result. Finally, a second process operation is executed for subsequent manufacturing process.

### BACKGROUND OF THE INVENTION

1. Field of the Invention

The present invention relates to a carrier transfer technology, and in particular to a computer-implemented method of automatic carrier transfer.

2. Description of the Related Art

With the progress of the IC manufacturing technology and advances in computer integrated manufacturing systems (CIM system) therefor, multiple lots can be stored in one carrier and applied to different manufacturing recipes within a manufacturing process, especially in a 300MM IC foundry. A critical issue of production efficiency of the IC foundry is application of the stored lots in one single carrier to different operation tools.

Thus, for better manufacturing tool utilization, carrier transfer operations for wafers are executed manually, such as Sort and Merge (S&M) operations. Approximately 15%˜20% of labor resources per day are devoted to manual carrier transfer operations. Manual operation executed on the production line, however, cause inconsistency of quality, thus, automatic carrier transfer is an important concern for the IC foundry.

Carrier transfer operations may appear in diverse manufacturing processes, such as contamination carrier transfer, clean due carrier transfer, or E/Runcard. It is extremely difficult to determine which processes require carrier transfer operations, arranging the carrier transfer operations immovably in the manufacturing recipe. However, with the fixed manufacturing recipe being a key requirement of the IC foundry automation, the manual carrier transfer operations diminish production efficiency.

### SUMMARY OF THE INVENTION

Accordingly, an object of the invention is to provide a method of automatic carrier transfer. The inventive method produces carrier transfer sub-routes dynamically in a regular production route according to the manufacturing request. The sub-routes are produced and executed without affecting the regular production route, thereby enhancing the production automation of IC foundries.

To achieve the foregoing and other objects, the invention is directed to novel systems and methods for overcoming conventional carrier transfer problems. First, a data verification procedure is executed after a first wafer process operation of wafers according to a MES (manufacturing execution system) database. The data verification procedure verifies the data between the physical wafers and the MES database. A verification result is obtained through the data verification procedure. The verification result indicates whether a carrier transfer operation is required, and, if so, a carrier transfer sub-route is then produced and executed. The carrier transfer sub-route may transfer wafers in one carrier to different carriers or split the wafers in one carrier and then transfer the split lots to different carriers. Finally, a second process operation is executed for subsequent manufacturing processes.

### BRIEF DESCRIPTION OF THE DRAWINGS

The present invention can be more fully understood by reading the subsequent detailed description and examples with references made to the accompanying drawings, wherein:

FIG. 1 is a flowchart of a computer-implemented method of automatic carrier transfer according to the invention.

FIG. 2 is a diagram of a storage medium for storing a computer program providing a method of automatic carrier transfer according to the invention.

FIG. 3 is a diagram of a system of automatic carrier transfer according to the invention.

FIG. 4 is a diagram of wafer process operations of the method of automatic carrier transfer according to the invention.

FIG. 5 is a diagram of wafer process operations of the method of automatic carrier transfer according to the invention.

FIG. 6 is a diagram showing execution of the carrier transfer sub-route according to one embodiment of the invention.

FIG. 7 is a diagram showing execution of the carrier transfer sub-route according to one embodiment of the invention.

### DETAILED DESCRIPTION OF THE INVENTION

As summarized above, the present invention is directed to novel systems and methods for overcoming conventional carrier transfer problems. In one embodiment, the inventive method first executes a data verification procedure according to a MES database after a first process operation and obtains a verification result. The data verification procedure verifies the data between the wafers and the MES database.

A verification result is obtained through the data verification procedure. If a carrier transfer operation is required by a process operation, such as over clean due process, the method then produces a carrier transfer sub-route of the wafers according to the verification result. Next, the produced carrier transfer sub-route is executed and the MES database is updated thereafter. The carrier transfer sub-route may transfer the wafers in one carrier to a different carrier or split the wafers and then transfer the split lots to different carriers.

A second process operation for the wafers is then executed. The disclosed first and second process operations may be stored in a first database and the carrier transfer sub-route may be stored in a second database. For actual implementation, the first and second databases can be integrated into a single database or separated into different databases.

Through the inventive method, the carrier transfer sub-routes can be produced dynamically in the regular process operation route, the first and second process operations, reducing dependence on manual operation. The disclosed method also accomplishes the goal of saving storage space operation data. As an example, if the regular production route requires 1000 operations and 10 carrier transfer operations, then a total of 10000 operations must be stored in the database by conventional methods. The inventive method, however, produces the carrier transfer sub-routes dynamically, requiring only a database to store the 1000 operations of the, regular production route and another database to store the 10 carrier transfer operations, enhancing the efficiency of data management.

In addition, the invention discloses a storage medium for storing a computer program providing a method of automatic carrier transfer. The method includes the steps disclosed.

Furthermore, the invention discloses a system of automatic carrier transfer. The system includes a first execution module, a sub-route production module, a sub-route execution module, and a second execution module.

The first execution module executes a data verification procedure according to a MES database after a first process operation and obtains a verification result. The verification procedure verifies the data between the physical wafers and the MES database.

The sub-route production module produces a carrier transfer sub-route according to the verification result. The sub-route execution module executes the produced carrier transfer sub-route of the wafers and updates the MES database. The carrier transfer sub-route may transfer the wafers in one carrier to a different carrier or split the wafers in one carrier and then transfer the split lots to different carriers. The second execution module executes a second process operation for the wafers. The first and second process operations can be stored in a first database and the carrier transfer sub-route can be stored in a second database.

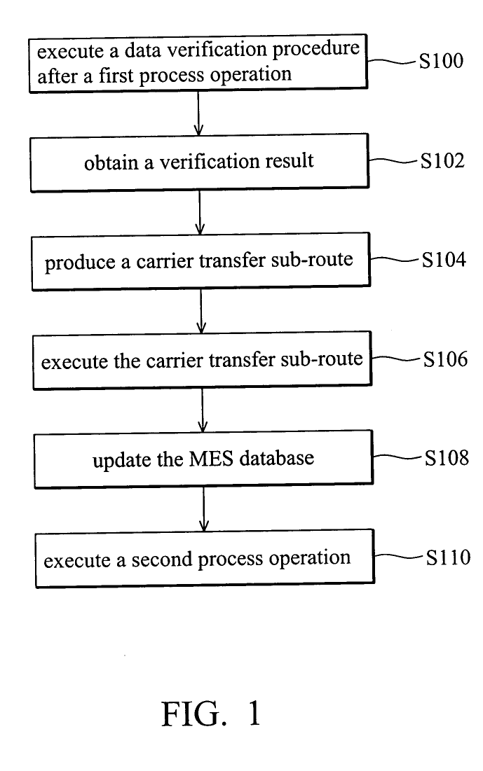

FIG. 1 is a flowchart of the computer-implemented method of automatic carrier transfer. First, a data verification procedure is executed according to a MES database after a first process operation (step S100). A verification result is then obtained by the verification procedure (step S102). The data verification procedure verifies the data between the physical wafers and the MES database.

Afterwards, a carrier transfer sub-route of the wafers is produced according to the verification result (step S104). The produced carrier transfer sub-route is executed (step S106) and the MES database is updated thereafter (step S108). The carrier transfer sub-route may transfer the wafers in one carrier to a different carrier or split wafers in one carrier and transfer the split lots to different carriers.

Finally, a second process operation for the wafers is executed (step S110) for subsequent process operations.

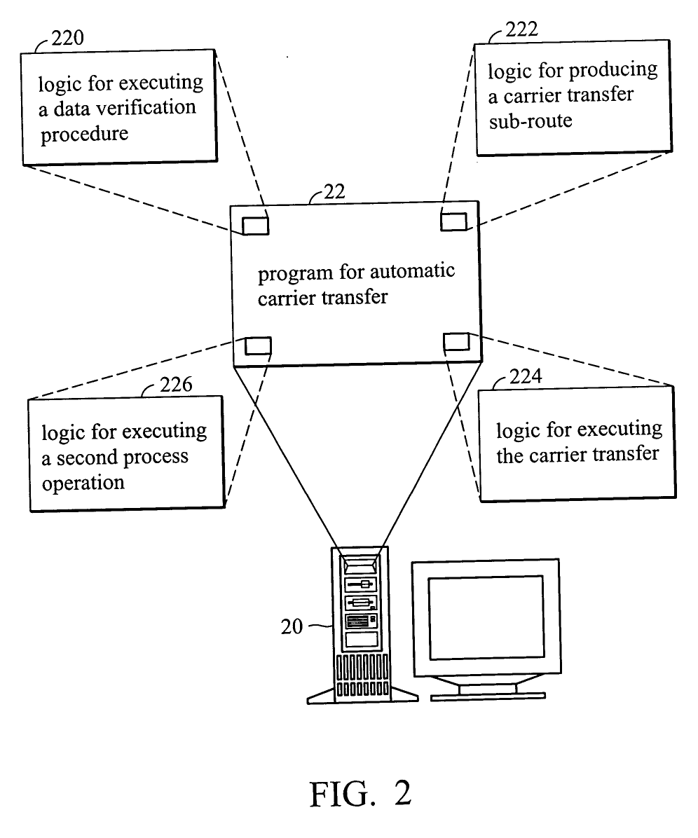

FIG. 2 is a diagram of the storage medium for storing a computer program providing a method of automatic carrier transfer. The storage medium 20 stores a computer program 22. The computer program 22 provides a method of automatic carrier transfer. The computer program 22 mainly includes logic for executing a data verification procedure 220, logic for producing a carrier transfer sub-route 222, logic for executing the carrier transfer 224, and logic for executing a second process operation 226.

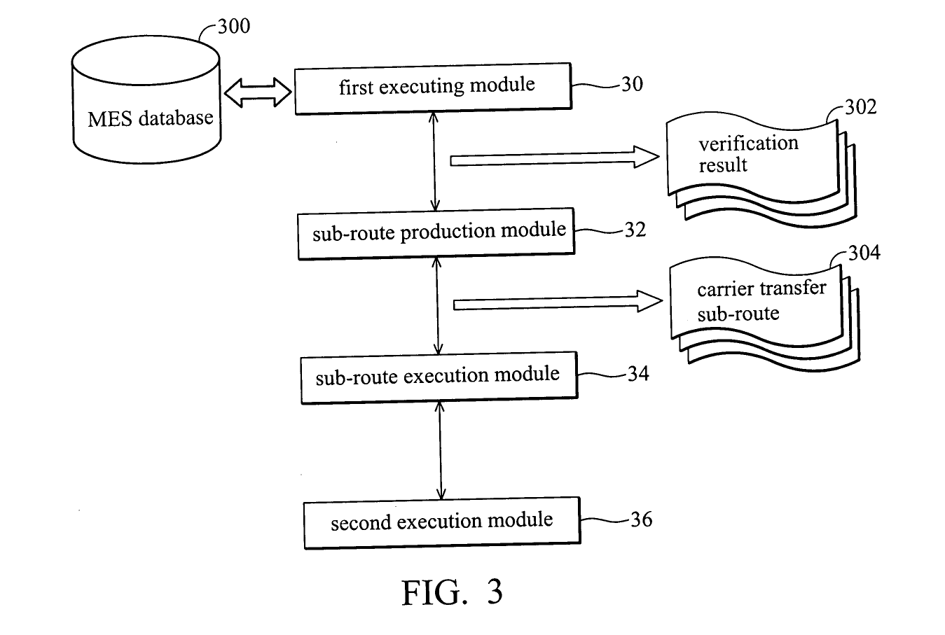

FIG. 3 is a diagram of the system of automatic carrier transfer. The system includes a first execution module 30, a sub-route production module 32, a sub-route execution module 34, and a second execution module 36.

The first execution module 30 executes a data verification procedure according to a MES database 300 after a first process operation and obtains a verification result 302. The sub-route production module 32, coupled to the first execution module 30, produces a carrier transfer sub-route 304 according to the verification result 302.

The sub-route execution module 34, coupled to the sub-route production module 32, executes the carrier transfer sub-route of the wafers 304. The sub-route execution module 34 also updates the MES database 300 after execution of the carrier transfer sub-route 304. The carrier transfer sub-route may include wafers transferred to different carriers and wafer lots split and transferred to different carriers.

The second execution module 36, coupled to the sub-route execution module 34, executes a second process operation for the wafers. The first and second process operations may be stored in a first database and the carrier transfer sub-route may be stored in a second database.

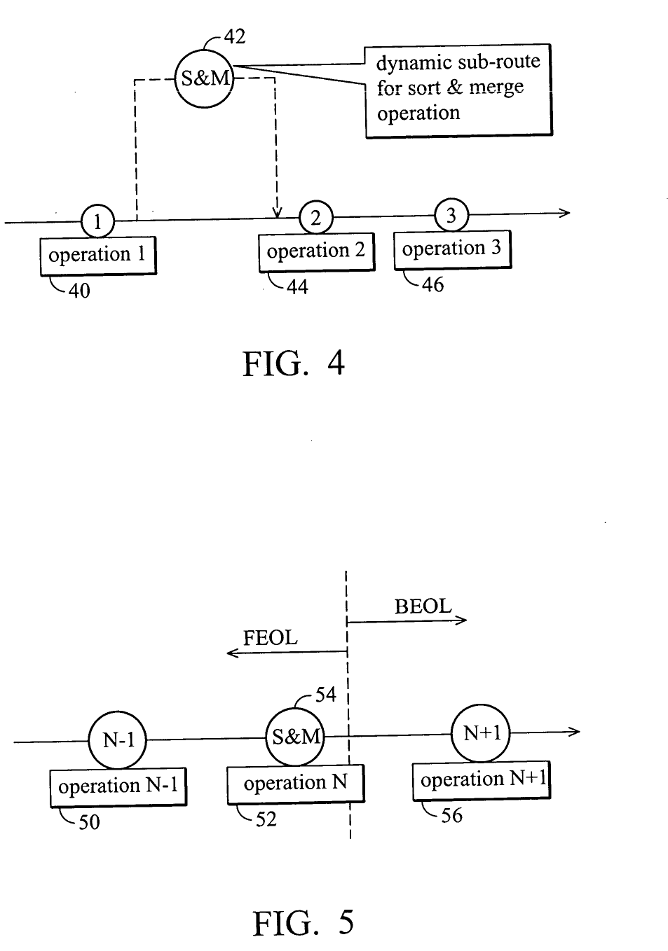

FIG. 4 is a diagram of wafer process operations of the method of automatic carrier transfer. For explanation, in one embodiment, the regular process operations are assumed as a first process operation (operation 1) 40, a second process operation (operation 2) 44 and a third process operation (operation 3) 46.

A data verification procedure is executed according to a MES database after the first process operation 40. A verification result is then obtained by the verification procedure. The data verification procedure verifies the data between the actual wafers and the MES database. If a carrier transfer sub-route is required according to the verification result, a carrier transfer sub-route 42 is then produced and executed, and the MES database is updated thereafter. The second and third wafer process operations 44, 46 are executed for subsequent process operations.

FIG. 5 is a diagram of wafer process operations of the method of automatic carrier transfer. In another embodiment, the regular wafer process operations are assumed as a first process operation (operation N−1) 50, a second process operation (operation N) 52, a carrier transfer sub-route 54, and a third process operation (operation N+1) 56.

A data verification procedure is executed according to a MES database after the first process operation 50. A verification result is then obtained by the verification procedure. The data verification procedure verifies the data between the operating wafers and the MES database. If the verification result shows that a carrier transfer operation is required after the second process operation 52, such as the critical point of pre-process operation (FEOL) and post-process operation (BEOL), the carrier transfer sub-route 54 is then executed. Continuing, a third wafer process operation 56 is executed for subsequent process operations.

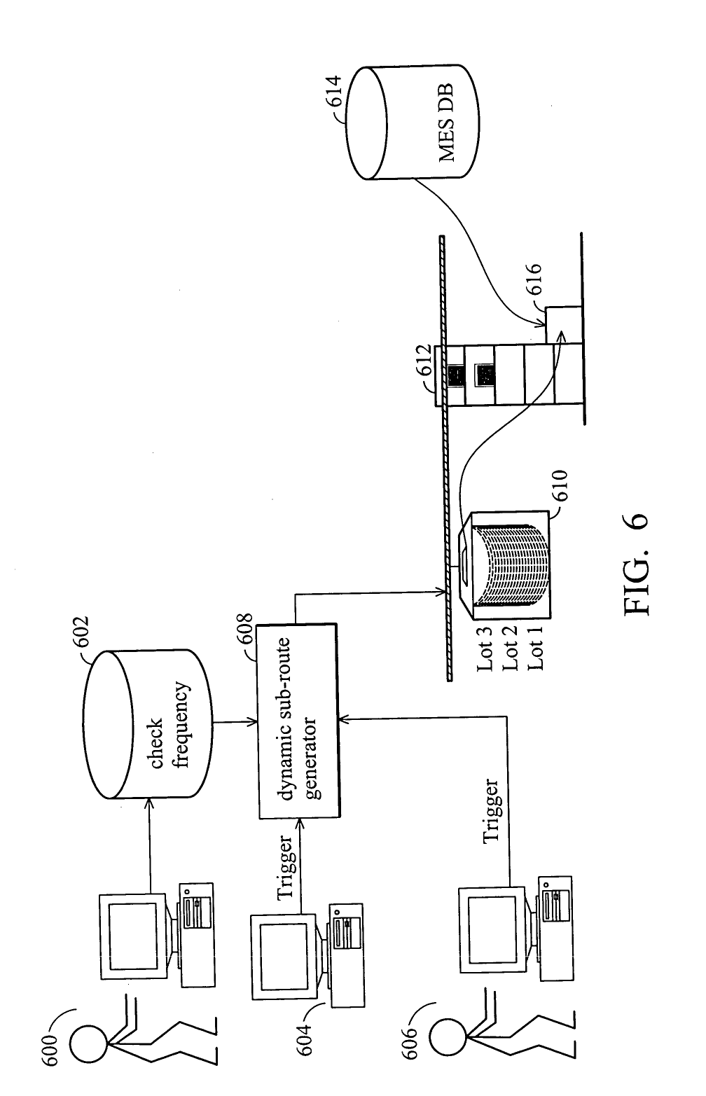

FIG. 6 is a diagram showing execution of the carrier transfer sub-route. In one embodiment, the carrier transfer sub-route is applied to wafer verification. Thus, a system of automatic carrier transfer is established. An administrator 600 or a program 604 can execute a data verification procedure 602 and produce a carrier transfer sub-route 608. For actual wafer verification, an operator 606 can also trigger the carrier transfer sub-route 608 for special or urgent requirements. The data verification procedure verifies the data between the wafers 610 in the production line and the MES database 614 to extract the abnormal lots, avoiding interference with the system. If the verification result requires carrier transfer then the carrier transfer sub-route transfers the wafers 610 to different carriers. The carrier transfer sub-route can be executed in a stocker 612 and an embedded sorter 616.

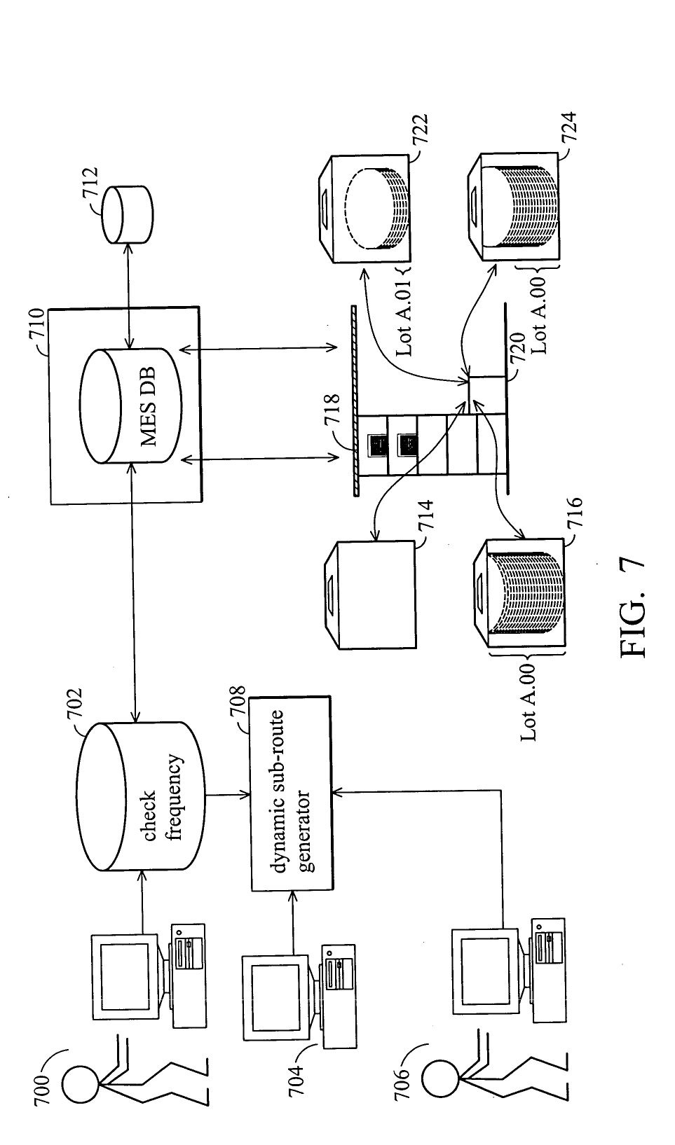

FIG. 7 is a diagram showing execution of the carrier transfer sub-route. In another embodiment, a system of automatic carrier transfer is established. An administrator 700 or a program 704 can execute a data verification procedure 702 and produce a carrier transfer sub-route 708. In addition, an operator 706 can trigger the carrier transfer sub-route 708 if necessary. The data verification procedure verifies the data between the operating wafers 716 and the MES database 710. The MES database 710 may refer to other database 712. If the verification result requires wafer lots to be split and transferred, the carrier transfer sub-route first splits the wafers 716 and then transfers the split lots to the different carriers 722, 724. The carrier transfer sub-route can be executed in a stocker 718 and an embedded sorter 720. After the carrier transfer sub-route, the original wafers (Lot A.00) 716 are split into two different carriers 722, 724, with different Lot IDs (LotA.00, Lot A.01). The empty carrier 714 will be filled with the split lots through the carrier transfer sub-route. Lot A.00 722 and Lot A.01 724 may be applied to different processes for subsequent process operations.

Thus, a method of automatic carrier transfer is provided by the invention. The disclosed method produces a carrier transfer sub-route dynamically to achieve the production automation, presenting significant advantages in IC foundries.

It will be appreciated from the foregoing description that the system and method described herein provide a dynamic and robust solution to the carrier transfer problem. If, for example, carrier transfer sub-routes are required in different processes, the system and method of the present invention can revise the executing times of the carrier transfer sub-routes to fit the actual requirement of production line.

The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A computer-implemented method of automatic carrier transfer, comprising using a computer to perform the steps of:
executing a data verification procedure after a first process operation of a plurality of wafers according to a manufacturing execution system database and obtaining a verification result, wherein the data verification procedure verifies the data between the wafers and the MES database;
dynamically producing a carrier transfer sub-route of the wafers according to the verification result;
executing the carrier transfer sub-route of the wafers; and
executing a second process operation for the wafers.

2. (canceled)

3. (canceled)

4. The computer-implemented method as claimed in claim 1, wherein executing the carrier transfer sub-route further comprises updating the MES database.

5. The computer-implemented method as claimed in claim 1, wherein the carrier transfer sub-route is enabled by transferring the wafers from a first carrier to a second carrier.

6. The computer-implemented method as claimed in claim 1, wherein the carrier transfer sub-route is enabled by splitting the wafers in the first carrier and transferring the split lots to at least two carriers.

7. The computer-implemented method as claimed in claim 1, wherein the first process operation and the second process operation are stored in a first database.

8. The computer-implemented method as claimed in claim 7, wherein the carrier transfer sub-route is stored in a second database.

9. A storage medium for storing a computer program providing a method of automatic carrier transfer, comprising using a computer to perform the steps of:
executing a data verification procedure after a first process operation of a plurality of wafers according to a manufacturing execution system database and obtaining a verification result, wherein the data verification procedure verifies the data between the wafers and the MES database;
dynamically producing a carrier transfer sub-route according to the verification result;
executing the carrier transfer sub-route of the wafers; and
executing a second process operation for the wafers.

10. (canceled)

11. (canceled)

12. The storage medium as claimed in claim 9, wherein the step of executing the carrier transfer sub-route further comprises updating the MES database.

13. The storage medium as claimed in claim 9, wherein the carrier transfer sub-route is enabled by transferring the wafers from a first carrier to a second carrier.

14. The storage medium as claimed in claim 9, wherein the carrier transfer sub-route is enabled by splitting the wafers in the first carrier and transferring the split lots to at least two carriers.

15. The storage medium as claimed in claim 9, wherein the first process operation and the second process operation are stored in a first database.

16. The storage medium as claimed in claim 15, wherein the carrier transfer sub-route is stored in a second database.

17. A system of automatic carrier transfer, comprising
a first execution module, executing a data verification procedure after a first process operation of a plurality of wafers according to a manufacturing execution system database and obtaining a verification result, wherein the data verification procedure verifies the data between the wafers and the MES database;
a sub-route production module, coupled to the first execution module, dynamically producing a carrier transfer sub-route according to the verification result;
a sub-route execution module, coupled to the sub-route production module, executing the carrier transfer sub-route of the wafers; and
a second execution module, coupled to the sub-route execution module, executing a second process operation for the wafers.

18. (canceled)

19. (canceled)

20. The system as claimed in claim 17, wherein the sub-route execution module further updates the MES database.

21. The system as claimed in claim 17, wherein the carrier transfer sub-route is enabled by transferring the wafers from a first carrier to a second carrier.

22. The system as claimed in claim 17, wherein the carrier transfer sub-route is enabled by splitting the wafers in the first carrier and transferring the split lots to at least two carriers.

23. The system as claimed in claim 17, wherein the first process operation and the second process operation are stored in a first database.

24. The system as claimed in claim 23, wherein the carrier transfer sub-route is stored in a second database.

25-32. (canceled)

33. A computer-implemented method of automatic carrier transfer, comprising using a computer to perform the steps of:
executing a data verification procedure after a first process operation of wafers according to a manufacturing execution system database to obtain a verification result, the data verification procedure verifying data between the wafers and the MES database;
dynamically selecting a carrier transfer sub-route of the wafers according to the verification result;
executing the carrier transfer sub-route of the wafers; and
executing a second process operation for the wafers;
wherein the first process operation and the second process operation are stored in a first database and are selected for processing of the wafers prior to executing the first process operation; and
wherein the carrier transfer sub-route is stored in a second database.
